(19) United States
(12) Patent Application Publication
(10) Pub. No.: US 2010/0109399 A1
(43) Pub. Date: May 6, 2010

(54) Universal booster seat cover

(76) Inventors: Elizabeth B. Rockwell, Pittsburgh, PA (US); Carrie A. Eckenrod, Pittsburgh, PA (US)

Correspondence Address: DILWORTH PAXSON LLP, 1500 Market Street, Suite 3500 E, PHILADELPHIA, PA, 19102, US

(21) Appl. No.: 12/589,271

(22) Filed: Oct. 21, 2009

Related U.S. Application Data
(60) Provisional application No. 61/196,996, filed on Oct. 21, 2008.

(51) Int. Cl. A47C 31/00; A47D 1/00; B60N 2/26

(52) U.S. Cl. 297/219.12

(57) ABSTRACT

A removable booster seat cover is provided for use with a backless booster seat. The seat cover provides an easily removable, replaceable, washable and adjustable cover that is configured universally to fit all different makes and models of backless booster seats. The seat cover provides an elasticized opening along its bottom side. A buttonhole opening and a drawstring closure with cord stop may be provided for adjustable fit. The elastic adjustable hem is configured to be slipped over and secured around the backless booster seat. Two elastic openings through the seat cover are provided to slip arm rests on the backless booster seat through. The seat cover may be comprised of multiple layers of fabric, cushion material, and fusible interfacing/waterproof backing material.

### CROSS REFERENCE TO RELATED APPLICATION

This application claims the priority and benefit of U.S. Provisional Patent Application Ser. No. 61/196,996 entitled “Universal Backless Booster Seat Cover” filed Oct. 21, 2009, the entirety of which is incorporated herein by reference.

### FIELD OF THE INVENTION

The invention relates to car booster seat covers, and, more specifically, to a universal car seat cover capable of fitting all backless booster seats.

### DESCRIPTION OF THE ART

Various forms of automotive car seats for children may be used. As children grow older, and thus grow larger, different types of automotive car seats may be used to ensure their safety. When children are their youngest, infant car seats are used. Infant car seats face rearward and can double as a child carrier, but are only used until the child weighs about 20 pounds, or is about 6-months to one-year old. When a child's weight reaches about twenty pounds, the infant seat may be switched out and replaced with a forward facing car seat. Forward facing car seats generally are not usable as carriers, and stay fixed to the car seat. Finally, when the child reaches 30-40 pounds, a booster seat is typically used for automotive travel.

Booster seats are for toddlers, and are to be used in automotive travel until a certain age and/or weight, depending on applicable state law, is reached. Booster seats keep the child in a forward facing position, and are available either with, or without, a back. For safety reasons, some child safety advocates recommend that all children ride in automotive booster seats until they reach a weight of eighty pounds. Although children grow quickly, it's common for an automotive booster seat to see years of use before being outgrown by its passenger(s) or simply worn out. Some automotive booster seats may even see more than five years of consecutive use, especially in families having more than one child.

During the course of use, automotive booster seats withstand a significant amount of abuse, being soiled by bodily fluids, drink spills and food, among other things. Generally, automotive booster seats have a fabric covering, which typically absorbs the spills and soiling, and is dirtied easily. Consequently, automotive booster seats, especially those seeing years of duty, may become extremely unsightly. Automotive booster seats can also wear out through use. Currently, no one manufactures a cover which is capable of covering and protecting all currently manufactured backless automotive booster seats.

### SUMMARY OF THE INVENTION

The present invention provides a universal automotive backless booster seat cover which allows parents to protect automotive backless booster seats, so that they remain in new condition through years of use.

The present invention provides a generally convex cover for a backless booster seat. The cover comprises at least at least one layer of flat material having a top surface, a bottom surface, and an edge along a perimeter of the material. The cover also comprises at least one stitch sewn along the flat material. The stitch affixes the piece of fabric to itself, and a first end of the stitch is at a fixed point of the piece of fabric and a second end of the stitch joins two remote points along the outside perimeter of the flat material. The cover also comprises two communications symmetrically positioned along a lengthwise axis of the at least one layer of flat material, wherein the two communications are adapted to receive arm rests of a booster seat. The cover comprises further at least one securement mechanism affixed to the material.

The backless booster seat may comprise a cushion material having a top surface and a bottom surface is affixed along the top surface of the cushion layer to the bottom surface of the flat material of the cover. A backing material having a top surface and a bottom surface may be affixed along the top surface of the backing material to the bottom surface of the cushion layer of the cover. In an alternative embodiment, the backing material having a top surface and a bottom surface may be affixed along the top surface of the backing material to the bottom surface of the flat material.

The backless booster seat cover may be adapted to contact the general surface contours of a backless booster seat.

An adjustable elastic material may be affixed along an edge of each of the two communications. In an embodiment, at least one securement mechanism may comprise an adjustable elastic hem having an internal drawstring closure and cord stop. In an alternative embodiment, at least one securement mechanism may comprise an adjustable elastic hem and at least one piece of Velcro affixed along a bottom surface of the booster seat cover. The at least one piece of Velcro may be adapted to removeably affix to a corresponding piece of Velcro positioned along a surface of the booster seat.

The present invention also provides a universal cover for a backless booster seat. The universal cover comprises at least one layer of fabric having a bottom surface, and at least one layer of backing material affixed to the bottom surface of the at least one layer of fabric. The at least one layer of fabric and the at least layer of backing material provides a convex conformation adapted to generally contact a surface of a backless booster seat.

At least one layer of cushion material may be provided between the at least one layer of fabric and the at least one layer of backing material.

Two communications may be provided through the universal cover. The two communications are positioned through the universal cover to adapt to arms of a booster seat.

At least one stitch may be provided to affix a first edge of the fabric to a second edge of the fabric. A first end of the first edge and a first end of the second edge may terminate at one point on universal cover, and the second end of the first edge and the second end of the second edge may be remotely positioned along a perimeter of the universal cover.

A securement mechanism may be provided along a perimeter of the universal seat cover. The securement mechanism may comprise an elastic hem enclosing a drawstring. The elastic hem may be stitched to the at least one layer of material and the at least one layer of backing material. In an alternative embodiment, the securement mechanism may comprise an elastic hem and at least one piece of Velcro affixed along the bottom surface of the universal cover. The at least one piece of Velcro may be configured to engage a corresponding piece of Velcro affixed to a surface of the booster seat.

The present invention also provides a conformable cover for a backless booster seat. The cover comprises at least one layer of material affixed to a first surface of at least one layer of cushion material, at least one layer of backing material affixed to a second surface of the at least one layer of cushion material, and an elastic hem is provided along an outside perimeter of the conformable universal cover. The elastic hem may be stitched to the at least one layer of material and the at least one layer of backing material. The conformable universal cover may be adaptable to contact an outside surface of the booster seat.

Two communications are provided through the conformable cover. The two communications may be configured to receive arms of the booster seat. The conformable cover may be configured in a convex shape.

At least one corresponding set of edges of the at least one layer of material are stitched together.

The at least one corresponding set of edges of the at least one layer of material allow the conformable cover to adapt to a booster seat.

The present invention also provides a universal automotive backless booster seat cover which replaces the appearance of older, soiled, and/or possibly worn-out backless booster seat covers, so that the booster seat may be reused.

The present invention also provides an easily removable machine washable universal automotive backless booster seat cover. The cover may be easily removed, cleaned, and returned to the backless booster seat for use.

The present invention also provides an aesthetically appealing universal backless booster seat cover that may be manufactured from a variety of fabrics or fabric-like materials having different designs printed or patterned thereon, thus allowing parents and children to customize the appearance of their automotive backless booster seat.

Additionally, the present invention also provides a cover which fits all forms of backless automotive booster seats, making it easy for parents to choose a backless booster seat cover, without worrying about model and size specifications in their purchase.

### BRIEF DESCRIPTION OF THE DRAWINGS

FIG. 1(a) shows a scaled pattern for at least one of the fabric layers of the universal backless booster seat covers in accordance with an embodiment of the present invention.

FIG. 1(b) shows top views of both an unattached and attached universal backless booster seat cover in accordance with an embodiment of the present invention.

FIG. 2 shows a bottom view of a completed universal backless booster seat cover in accordance with an embodiment of the present invention.

FIG. 3 shows a cross-sectional view of an unattached universal backless booster seat cover.

FIG. 4 shows a rear view of a backless booster seat covered with a universal backless booster seat cover in accordance with an embodiment of the present invention.

FIG. 5 shows a bottom view of the front edge of the backless booster seat of FIG. 4 covered with a universal backless booster seat cover.

FIG. 6 shows a perspective top view of the top-front edge of the backless booster seat of FIG. 4 covered with a universal backless booster seat cover.

FIG. 7 shows a top view of the backless booster seat of FIG. 4 covered with a universal backless booster seat cover.

FIG. 8 shows a top view of the backless booster seat of FIG. 7.

FIG. 9 shows a perspective top view of the left-side and top of the backless booster seat of FIG. 4 covered with a universal backless booster seat cover.

FIG. 10 shows a perspective top view of the top and front of the backless booster seat of FIG. 4 covered with a universal backless booster seat cover.

FIG. 11 shows a view of an alternative pattern for at least one of the fabric layers of the universal backless booster seat cover in accordance with another embodiment of the present invention.

### DESCRIPTION OF THE PREFERRED EMBODIMENTS

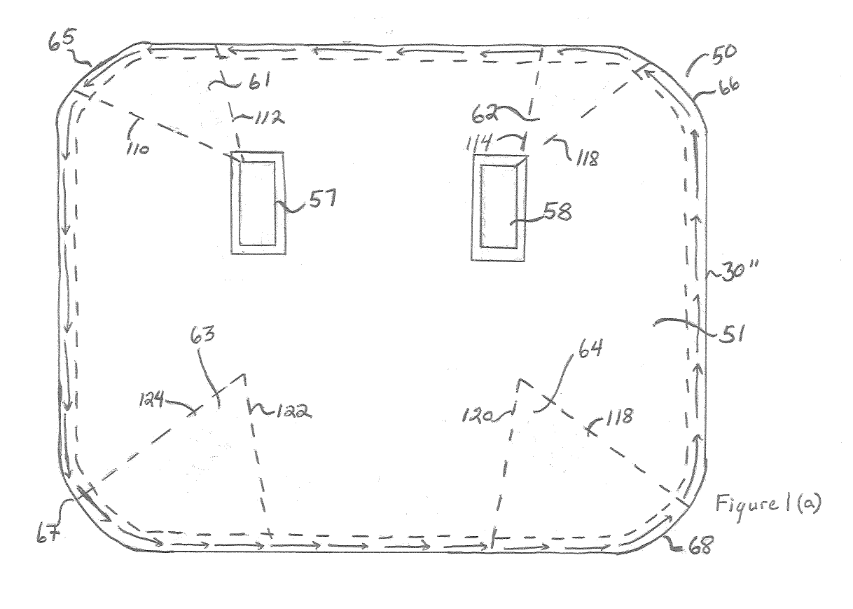

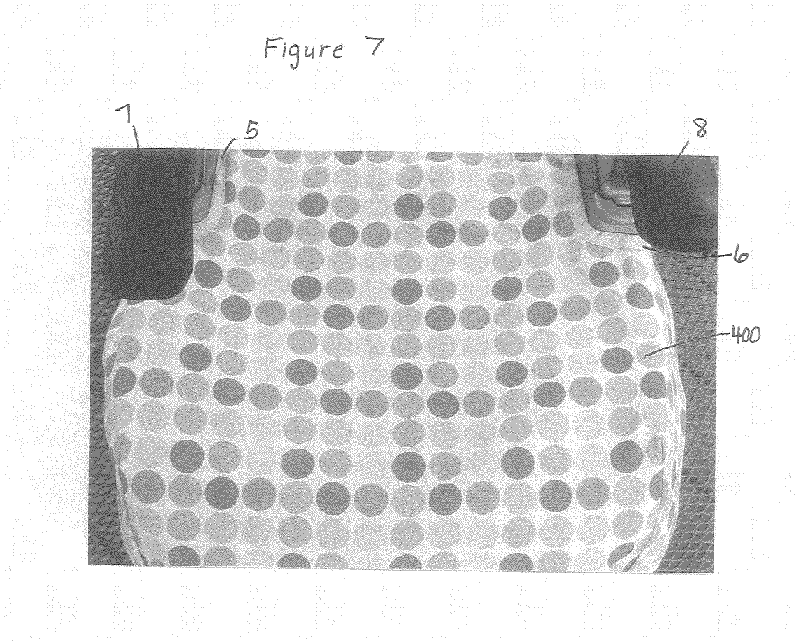

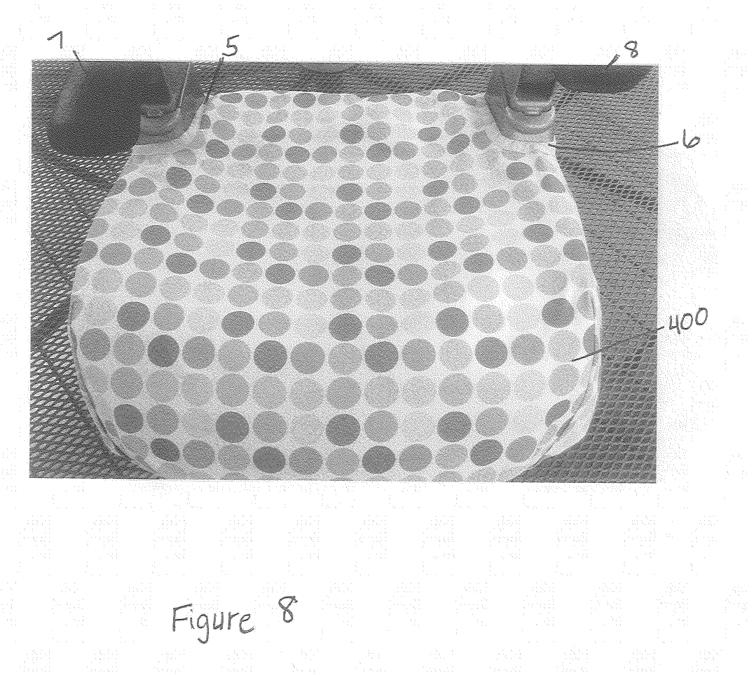

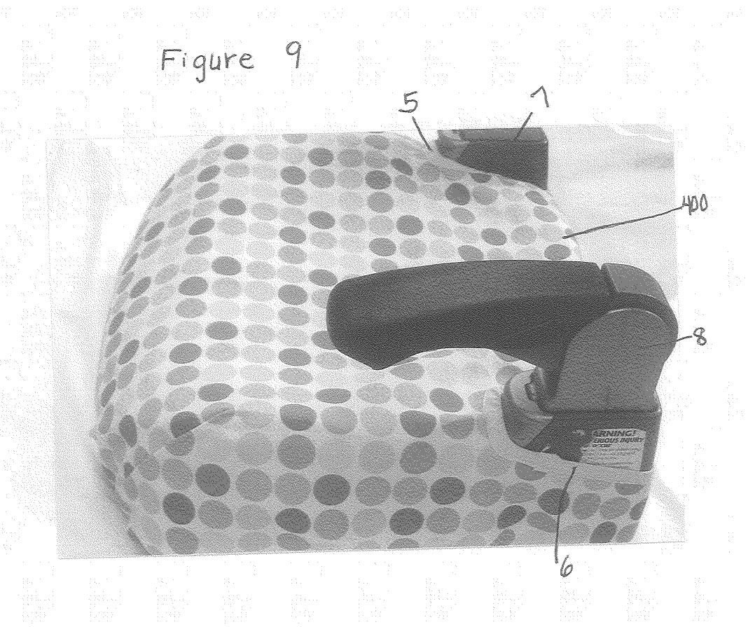

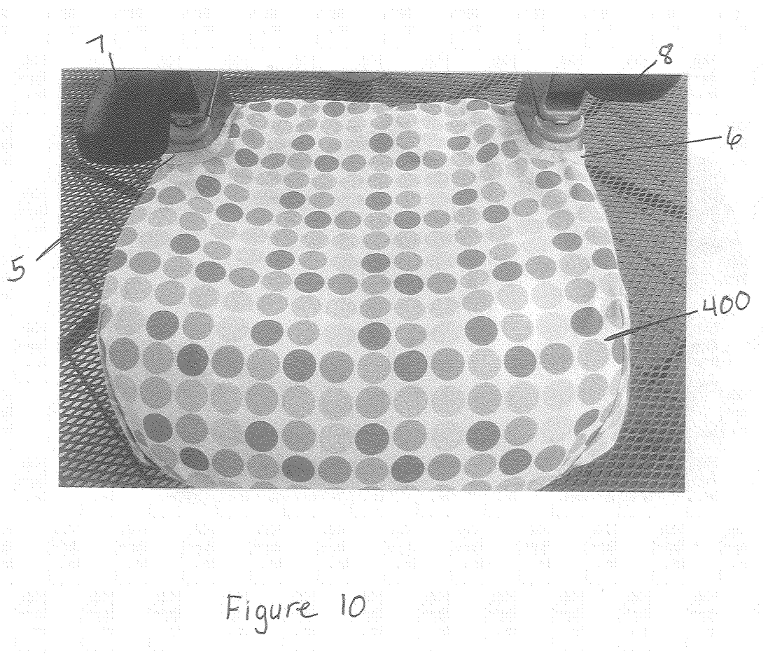

In reference to FIGS. 1 through 11, a universal cover for protecting and increasing the aesthetic appeal of backless booster seats is provided. The cover may comprise (1) a top layer of washable fabric, (2) a foam or cushion layer disposed underneath the top washable fabric layer, and (3) a fusible interfacing/waterproof backing underneath the foam layer, in accordance with one embodiment of the present invention. The cover may have one of the sides rounded outwards in an embodiment of the present invention.

The phrase “backless booster seat” is used in the singular and plural throughout the instant specification. Backless booster seats are defined as automotive booster seats without a back, or automotive booster seats with removable back, and having the back removed. Backless booster seats do not include automotive booster seats having fixed, or irremovable backs.

Along the four outside edges, or the perimeter of the cover, may be sewn an adjustable elastic hem. The adjustable elastic hem extends out of a buttonhole opening at one point along the perimeter, providing the user with drawstring closure and cord stop. Alternatively, attachment mechanisms, such as, elastic, Velcro, and other friction surfaces or enclosure structures may be provided with the present invention. Interior to the at least one fabric layer cut two arm rest holes are provided. The holes are generally symmetrically in position over the lengthwise axis of the cover and have elastic sewn into the perimeters of the cut arm rest holes to provide partial closure of the holes.

Generally, the universal backless booster seat cover may be used as follows. The cover is placed upon a backless booster seat so that the arm rests protrude through the arm rest holes cut in the cover. The bottom surface of the top washable layer, or, if used, the fusible interfacing/washable backing should then be resting upon the seat surface (top surface) of the backless booster seat. The elastic sewn into the perimeter of the cut arm rest holes ensures that the holes adjust to the size of the arm rests, fitting snugly, so that excess fabric is not snagged by clothing or buckles, and that items do not fall and become lodged underneath the cover. The elastic perimeter of the cover may then be tucked underneath the bottom of the backless booster seat so that the top and sides of the booster are fully covered. To facilitate tucking the elastic perimeter of the cover under the backless booster seat, the backless booster seat may be flipped over. The drawstring closure may then be pulled taut, and the cord stop may next be adjusted, to prevent any excess length of drawstring from reentering the perimeter, and loosening the cover. The backless booster seat, with the cover attached may then be positioned in a vehicle, with the drawstring and cord stop tucked underneath, between the backless booster seat and the automotive seat.

Referring now to FIG. 1(a), a pattern for a top fabric layer 51 of the universal backless booster seat cover, in accordance with an embodiment of the present invention, is shown. The top fabric layer 51 may be about 37 inches wide and 30 inches long, and may have rounded corners 65-68, as shown in FIG. 1(a). Alternative dimensions may be used to adapt the universal backless booster seat cover for use with booster seats. Bound regions 61-64 are generally triangular regions, each being proximate to one of the rounded corners 65-68. Bound region 61 is proximate to rounded corner 65; bound region 62 is proximate to rounded corner 66; bound region 63 is proximate to rounded corner 67; and bound region 64 is proximate to rounded corner 68. Bound regions 61 and 62 are approximately 40 square inches in area, and bound regions 63 and 64 are approximately 69 square inches in area. Each of the triangular shaped bound regions has two edges internal to the surface of the top fabric layer 51. These two edges of each of bound regions 61-64 are sewn together along edges 110 through 124, gathering the fabric between corresponding edges 110 through 124 at each bound region, and giving the top fabric layer 51 an overall generally convex three dimensional conformation which contacts at least the top, side, and possibly a portion of the bottom surface of a backless booster seat.

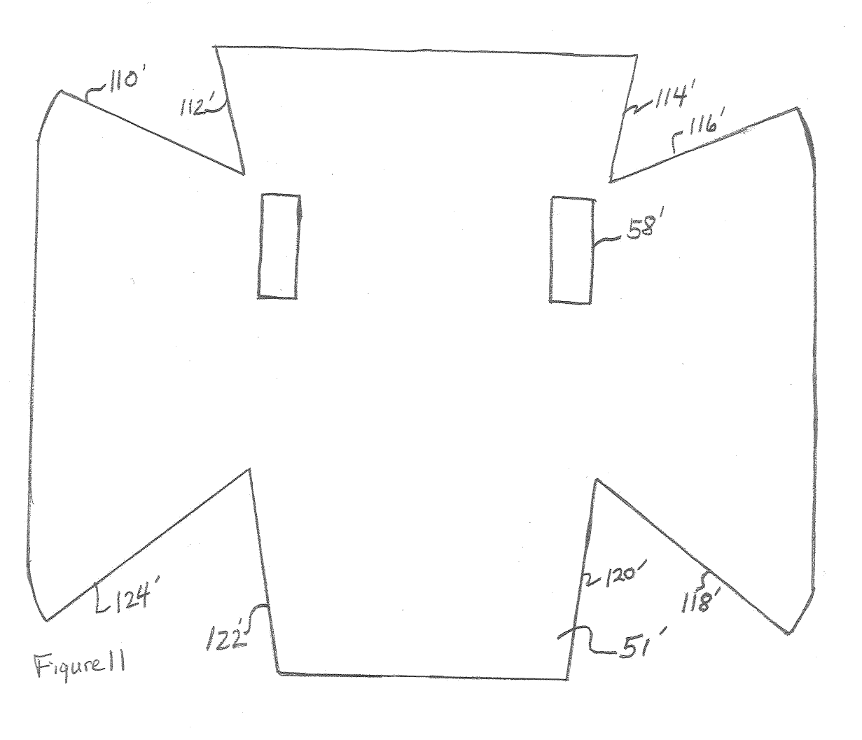

Referring now to FIG. 11, in an alternative embodiment of the top fabric layer 51′ of the present invention, the bound regions 61-64 as shown in FIG. 1(a) in top fabric layer 51 may be cut out and removed entirely, and the converging edges 1101 through 124′ created from each cut-out, at each corner, may be sewn together.

Together, bounded regions 61-64 sewn together along edges 110 through 114 and rounded corners 65-68 of FIG. 1(a) and edges 110′ through 124′ of FIG. 11, reduce the overhang or gathering of excess fabric of the completed universal backless booster seat cover, and assist in conforming the universal booster seat cover to the variety of backless booster seats currently manufactured. Backless booster seats generally have rounded edges and corners. Having un-rounded, or squared edges and corners on the universal backless booster seat cover would create bunches of fabric which may cause discomfort for the child-passenger. Additionally, non-conforming edges and corners may trap spills and soiling, or be easily snagged by loose clothing and buckles.

Located to the interior of the top fabric layer 51 and 51′ are two arm rest cut-outs, 57 and 58 in FIG. 1(a) and arm-rest cut-outs, 57′ and 58′ in FIG. 11. Arm rest cut-outs 57 and 58 in FIG. 1(a) and arm-rest cut-outs, 57′ and 58′ in FIG. 11 are each about 2 inches wide by about 5 inches long, or about 10 square inches of fabric. Each of arm rest cut-outs 57 and 58 in FIG. 1(a) and arm-rest cut-outs, 57′ and 58′ in FIG. 11 may be about 7 inches away from the back edge of the top fabric layer 51 or fabric layer 51′ respectively at each of the cut-outs' closest points, and about 10.5 inches away from the nearest side edge of top fabric layer 51 at each of the cut-outs' closest points.

Referring to FIG. 1(b), an unattached universal backless booster seat cover 100, and an attached backless booster seat cover 150, are shown, in accordance with an embodiment of the present invention. Unattached universal backless booster seat cover 100 is shown to comprise an outer elastic hem 3, arm rest holes 107 and 108, elastic openings 5 and 6, one or more fabric layers 1, buttonhole opening 13, and drawstring closure with cord stop 4.

Attached backless booster seat cover 150 is substantially the same backless booster seat cover as cover 100, but cover 150 has been attached to a backless booster seat 2. Outer elastic hem 3, buttonhole opening 13, and drawstring closure with cord stop 4 are no longer visible on backless booster seat cover 150, because these elements are now tucked below the bottom of the backless booster seat 2, to which cover 150 is attached. Shown in the view of attached backless booster seat cover 150, arm rest 7 extends through arm rest hole 107 of unattached cover 100, and arm rest 8 extends through arm rest hole 108 of unattached cover 100.

In one embodiment of the present invention, one or more fabric layers 1 are cut to be about 37 inches long and 30 inches wide. One or more fabric layers 1 include a top fabric layer, comprising a washable or non-washable fabric or other material, which may or may not have patterning or printing on a surface. The patterning or printing on a surface increases the aesthetic appeal of the universal backless booster seat cover. The top fabric layer may be water repellent, or have applied another fabric treatment which prevents staining and absorption of spilled fluids and food, thus extending the life of the universal backless booster seat cover. The printed or patterned surface of the top fabric layer may be positioned so that it is the outer, or top surface, of the cover.

In one embodiment in accordance with the present invention, one of the longer rectangular edges of the at least one fabric layers (e.g., one of the edges of about 37 inches in length) may be trimmed to create a rounded convex edge, and better fit those backless booster seats with a rounded front seat edge.

In addition to the top fabric surface, at least one fabric layer 1 may include a foam or cushion layer, and a fusible interfacing/waterproof backing layer, both of which are discussed below.

Arm rest holes 107 and 108 are cut out of at least one fabric layer 1 of the universal backless booster seat cover. Arm rest holes 7 and 8 may be positioned symmetrically across the shorter axis of the at least one fabric layer 1. Arm rest holes 7 and 8 may be about 2 inches wide, and 5 inches long; and may be located about 7 inches from the back edge of the universal backless booster seat cover, and about 10 inches from each holes respective side edge of the universal backless booster seat cover. Aim rest holes 107 and 108 may be about 12 inches apart from each other.

Arm rests 7 and 8 of backless booster seat 2 are shown to protrude through the arm rest holes of attached universal backless booster seat cover 150 in FIG. 1(b). Backless booster seats have arm rests to ensure the comfort and safety of the child passengers, and the arm rest holes 107 and 108 ensure this functionality is maintained.

Along the perimeter of each of arm rest holes 107 and 108, elastic arm hole liners 5 and 6 may be sewn, respectively. Elastic arm hole liners 5 and 6, of arm rest holes 107 and 108, respectively, ensure that the arm rest holes create a snug fit with the different size arm rests of different manufactures of backless booster seats while also accommodating the different size arm rests. Additionally, once attached, backless booster seat cover 150 is fitted to backless booster seat 2 of FIG. 1(b), the elastic arm hole liners 5 and 6 help prevent items which are dropped or spilled on the seat from falling through, and underneath the cover 150. Elastic arm hole liners 5 and 6 also prevent bunching of excess fabric, or gaps from forming, which may be easily snagged by a child's clothing or buckles.

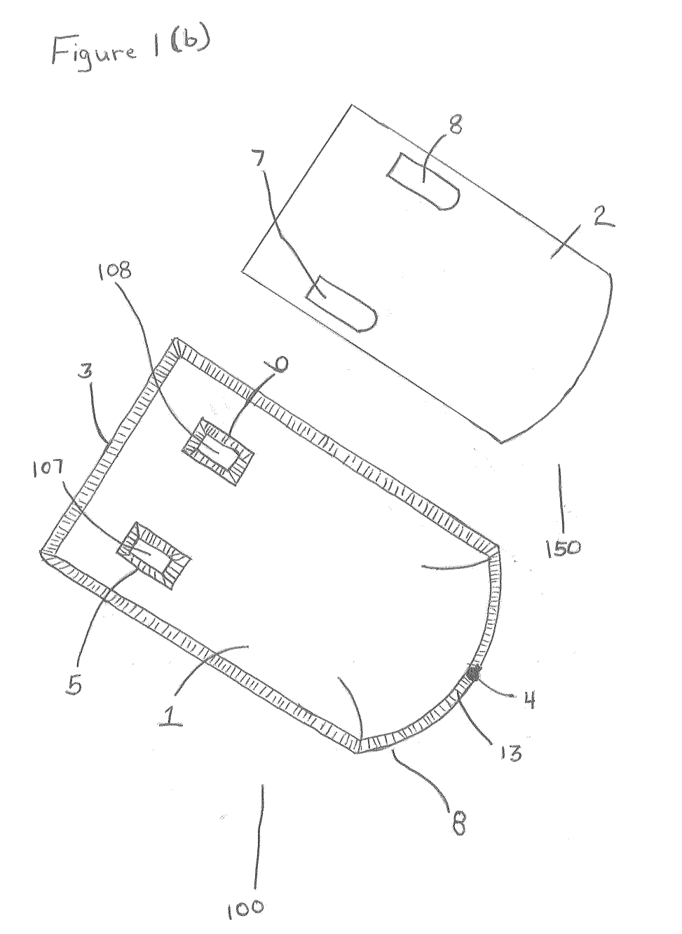

Referring now to FIG. 2, a bottom view of universal backless booster seat cover 200 is shown, in accordance with one embodiment of the present invention. At least one fabric layer 1 is shown to be drawn in by the adjustable elastic hem 3 and the tightening of drawstring closure with cord stop 4, through buttonhole opening 13. Through opening 9, fusible interfacing/waterproof backing layer 12 is visible. Fusible interfacing/waterproof backing layer 12 shares substantially the same dimensions as at least one fabric layer 1. Located in between backing layer 12 and at least one fabric layer 1 may be a layer of foam or cushion. The layer of foam or cushion is not visible in FIG. 2. If cover 200 were to be attached to a backless booster seat, then a portion of the bottom of the backless booster seat would be visible through opening 9, rather than the fusible interfacing/waterproof backing layer 12.

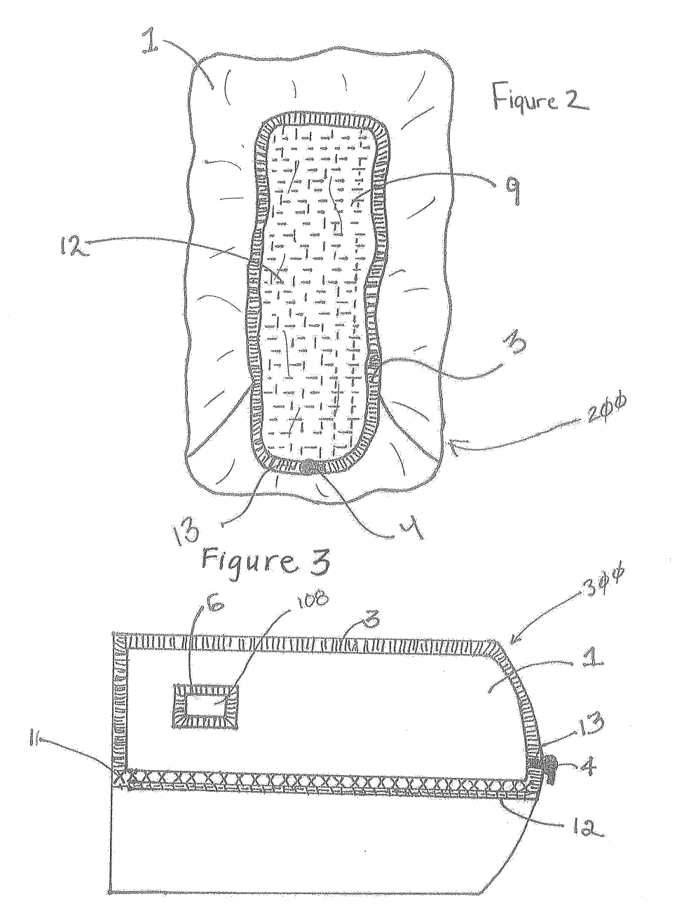

Referring to FIG. 3, a cross-sectional view of a universal backless booster seat cover 300 is shown in accordance with an embodiment of the present invention. Shown in FIG. 3 is at least one fabric layer 1, adjustable elastic hem 3, drawstring closure with cord stop 4, buttonhole 13, arm rest hole 108 and elastic arm hole liner 6, foam or cushion layer 11, and fusible interfacing/waterproof backing layer 12. As shown in FIG. 3, foam or cushion layer 11 may have substantially the same geometry of at least one fabric layer 1, and extend the length/width of cover 300.

Foam or cushion layer 11 is, for example, a one-half inch thick piece of foam or cushioning, located between at least one fabric layer 1 and fusible interfacing/waterproof backing layer 12. Foam or cushion layer 11 provides additional comfort to the child-passenger of the backless booster seat on which universal cover 300 is installed. Further, foam or cushion layer 11 may provide safety functionality, preventing injuries that may otherwise occur from bumping the harder plastic regions of the backless booster seat on which universal cover 300 is installed. Foam or cushion layer 11 may be thinner than one-half of an inch thick, or thicker than one-half of an inch thick, depending upon the amount of padding desired.

In alternative embodiments of the present invention, the foam or cushion layer 11 may not extend the full length (e.g., all 30×37 inches) of the at least one fabric layer 1. In such embodiments, the foam or cushion layer 11 may only be about 16 inches wide and 18 inches long, for example, or any other height and width dimensions which are able to provide sufficient comfort to a child for extended periods of sitting. Because a child sitting in a backless booster seat does not utilize the entire surface area of top surface as sitting area, extending the foam or cushion layer 11 further than necessary would be a waste of material. Additionally, excess foam or cushion may make fitting the universal seat cover 300 to, and removing the universal seat cover 300 from, a backless booster seat difficult.

In yet another embodiment in accordance with the present invention, no foam or cushion layer 11 may be located between at least one fabric layer 1 and fusible interfacing/waterproof backing 12. Many backless booster seats are manufactured with padding or cushions already installed, and additional cushion within the universal cover is duplicative. However, through extended periods of use, the manufacturers' padding or cushions may become matted, introducing discomfort and safety hazards to the child-passenger.

Where foam or cushion layer 11 is large enough to pass under the regions of at least one fabric layer 1 where arm rest holes 107 and 108 are cut, arm rest holes must also be cut in foam or cushion layer 11. Without cutting these adjacent holes in foam or cushion layer 11, the arm rests of the backless booster seat on which cover 300 is placed would be unable to pass through.

The universal backless booster seat cover may be made as follows. Cutting the at least one fabric layer and fusible interfacing/waterproof backing to about 37 inches by 30 inches. Cutting the foam or cushion layer to about 16 inches by 18 inches. Cutting arm rest holes in the necessary layers, for example, the top fabric surface, the fusible interfacing/waterproof backing, and the foam or cushion layer. Sewing elastics around the arm rest cut outs, and adding single fold bias tape to the edging, covering and reinforcing the seam. Optionally adhering the foam or cushion layer to the top fabric layer with spray or other adhesive. Optionally adhering fusible interfacing/waterproof backing to the foam or cushion later with spray adhesive. Creating a button hole opening at the front center edge of the top fabric layer, about one inch from the edge, and reinforcing the seam. Folding over the top fabric layer edge to create a 1 inch seam, sewing about 3.5 feet of elastic around the outer edge of the fabric, and securing with heavy duty thread and reinforced seams. Threading elastic through the edge of the material. Adding a drawstring closure with cord stop, and sewing the ends of the outer elastic.

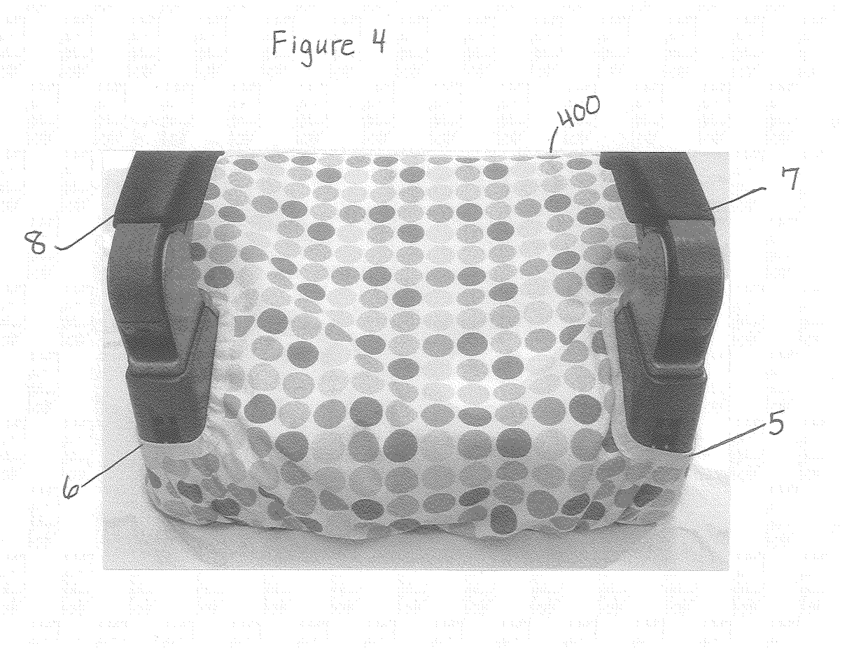

Referring now to FIG. 4 a universal backless booster seat cover 400 is shown in accordance with an embodiment of the present invention. As shown in FIG. 4, elastic arm hole liners 5 and 6 fit snugly around the base of arm rests 7 and 8, respectively. At least one fabric layer 1 is shown having a patterned outer surface, thus increasing the aesthetic appeal of the backless booster seat to which it is attached.

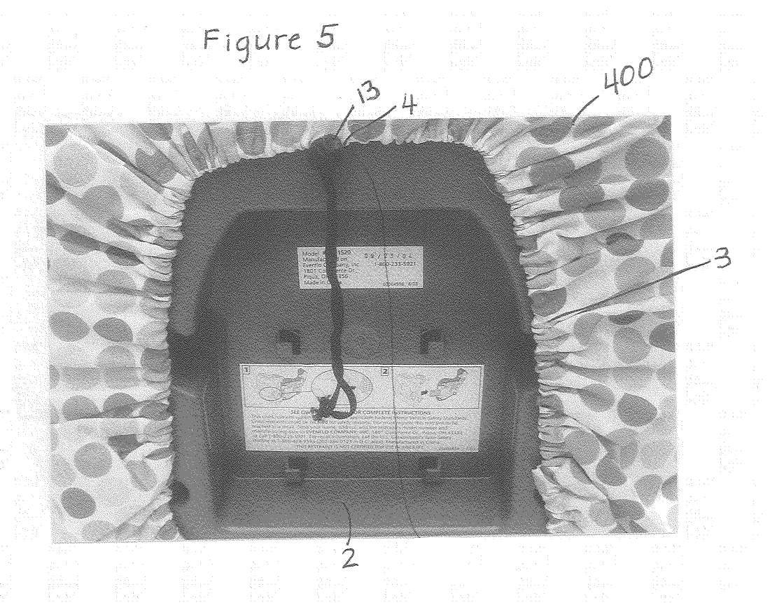

Referring now to FIG. 5, a bottom view of backless booster seat cover 400 is shown attached to backless booster seat 2. The elastic adjustable hem 3 of backless booster seat cover 400 has been pulled tight by drawstring closure with cord stop 4 through buttonhole 13. As can be seen in FIG. 5, the backless booster seat cover 400 fits snugly over backless booster seat 2, and the elastic adjustable 3 is neatly tucked underneath, thus fully protecting the top of backless booster seat 2 when placed in a car seat.

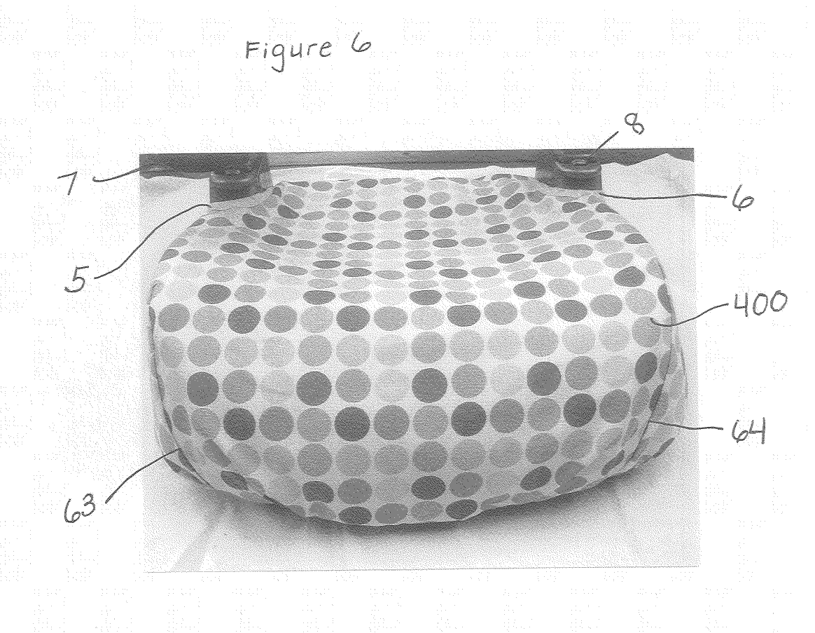

FIGS. 6-10 show alternative views of the backless booster seat cover 400 attached to backless booster seat 2. In FIG. 6, the seams along edges 110 through 114 resulting from sewing bound regions 63 and 64 are visible. The sewing of bound regions 63 and 64, as noted earlier in reference to FIG. 1(a) allows universal backless booster seat cover 400 to better conform to the backless booster to which it is attached. As shown in FIG. 6, there is little to no excess fabric in on the corners of the backless booster seat, providing a tight, custom fit appearance.

In FIGS. 6-10 elastic arm hole liners 5 and 6 are shown to fit snugly around the bases of arm rests 7 and 8 respectively. The snug fit around arm rests 7 and 8 prevents this region of fabric from being snagged by loose clothing or buckles, and from items falling underneath cover 400.

Modifications can be made to the embodiments described above without departing from the broad inventive concept thereof. Having described the preferred embodiments of the invention, additional embodiments, adaptations, variations, modifications and equivalent arrangements will be apparent to those skilled in the art. These and other embodiments will be understood to be within the scope of the appended claims and apparent to those skilled in the art.

We claim:

1. A generally convex backless booster seat cover comprising,
at least one layer of flat material having a top surface, a bottom surface, and an edge along a perimeter of the material;
at least one stitch sewn along the flat material wherein the stitch affixes the piece of flat material to itself, and wherein a first end of the stitch is at a fixed point of the piece of flat material and a second end of the stitch joins two remote points along the outside perimeter of the flat material;
two communications symmetrically positioned along a lengthwise axis of the at least one layer of flat material, wherein the two communications are adapted to receive arm rests of a booster seat; and
at least one securement mechanism affixed to the seat cover.

2. The backless booster seat of claim 1, wherein a cushion material having a top surface and a bottom surface is affixed along the top surface of the cushion layer to the bottom surface of the flat material.

3. The backless booster seat cover of claim 2, wherein a backing material having a top surface and a bottom surface is affixed along the top surface of the backing material to the bottom surface of the cushion layer.

4. The backless booster seat cover of claim 1, wherein a backing material having a top surface and a bottom surface is affixed along the top surface of the backing material to the bottom surface of the flat material.

5. The backless booster seat cover of claim 1, wherein the cover is adapted to contact the general surface contours of a backless booster seat.

6. The backless booster seat cover of claim 1, wherein an adjustable elastic material is affixed along an edge of each of the two communications.

7. The backless booster seat cover of claim 1, wherein at least one securement mechanism comprises an adjustable elastic hem having an internal drawstring closure and cord stop.

8. The backless booster seat cover of claim 1, wherein at least one securement mechanism comprises an adjustable elastic hem and at least one piece of Velcro affixed along a bottom surface of the booster seat cover, wherein the at least one piece of Velcro is adapted to removeably affix to a corresponding piece of Velcro positioned along a surface of the booster seat.

9. A universal cover for a backless booster seat comprising
at least one layer of fabric having a bottom surface; and
at least one layer of backing material affixed to the bottom surface of the at least one layer of fabric;
wherein the at least one layer of fabric and the at least layer of backing material provides a convex conformation adapted to generally contact a surface of a backless booster seat.

10. The universal cover for a backless booster seat of claim 9, wherein at least one layer of cushion material is provided between the at least one layer of fabric and the at least one layer of backing material.

11. The universal cover for a backless booster seat of claim 9, wherein two communications are provided through the universal cover, and wherein the two communications are positioned through the universal cover to adapt to arms of a booster seat.

12. The universal cover of a backless booster seat of claim 9, wherein at least one stitch is provided to affix a first edge of the fabric to a second edge of the fabric, wherein a first end of the first edge and a first end of the second edge terminate at one point on universal cover, and wherein the second end of the first edge and the second end of the second edge are remotely positioned along a perimeter of the universal cover.

13. The universal cover of a backless booster seat of claim 9, wherein a securement mechanism is provided along a perimeter of the universal seat cover.

14. The universal cover of a backless booster seat of claim 9, wherein the securement mechanism comprises an elastic hem enclosing a drawstring.

15. The universal cover of a backless booster seat of claim 9, wherein the securement mechanism comprises an elastic hem and at least one piece of Velcro affixed along the bottom surface of the universal cover, and wherein the at least one piece of Velcro is configured to engage a corresponding piece of Velcro affixed to a surface of the booster seat.

16. A conformable cover for a backless booster seat, comprising
at least one layer of material affixed to a first surface of at least one layer of cushion material;
at least one layer of backing material affixed to a second surface of the at least one layer of cushion material; and
an elastic hem is provided along an outside perimeter of the conformable universal cover;
wherein the elastic hem is stitched to the at least one layer of material and the at least one layer of backing material, and wherein the conformable universal cover is adaptable to contact an outside surface of the booster seat.

17. The conformable cover of claim 16, wherein two communications are provided through the conformable cover, and wherein the two communications are configured to receive arms of the booster seat.

18. The conformable cover of claim 16, wherein the conformable cover is configured in a convex shape.

19. The conformable cover of claim 16, wherein at least one corresponding set of edges of the at least one layer of material are stitched together.

20. The conformable cover of claim 19, wherein the at least one corresponding set of edges of the at least one layer of material allow the conformable cover to adapt to a booster seat.
